(19) United States
(12) Patent Application Publication
(10) Pub. No.: US 2021/0206229 A1
(43) Pub. Date: Jul. 8, 2021

(54) SYSTEM AND METHOD FOR CONTROLLING FLUID TEMPERATURE IN A THERMAL SYSTEM

(71) Applicant: GM GLOBAL TECHNOLOGY OPERATIONS LLC, Detroit, MI (US)

(72) Inventors: Michael A. Smith, Clarkston, MI (US); Eugene V. Gonze, Pinckney, MI (US); Sergio Quelhas, Ann Arbor, MI (US); Michael J. Paratore, JR., Howell, MI (US); Richard J. Lopez, Bloomfield, MI (US)

(73) Assignee: GM GLOBAL TECHNOLOGY OPERATIONS LLC, Detroit, MI (US)

(21) Appl. No.: 16/736,177

(22) Filed: Jan. 7, 2020

(51) Int. Cl. B60H 1/00

(52) U.S. Cl. CPC B60H 1/00735; B60H 2001/00171; B60H 1/00885; B60H 1/00485

(57) ABSTRACT

A system for controlling fluid temperature includes a heat source, a heat sink coupled to the heat source such that a flow of coolant passes between the heat source and the heat sink, a first heat exchanger coupled to the heat source, a second heat exchanger coupled to the heat source, a valve coupled to the heat source, the first heat exchanger, the second heat exchanger, and the heat sink, the valve configured to regulate the flow of coolant between the heat source, the first heat exchanger, the second heat exchanger, and the heat sink, and a controller in electronic communication with the heat source and the valve. The controller is configured to determine an operating condition and generate a control signal to control the valve to direct the flow of coolant to one or more of the first and second heat exchangers and the heat source.

### INTRODUCTION

The present disclosure relates generally to a system and method for controlling fluid temperature in a thermal system, specifically controlling engine oil and transmission oil temperature in a mechanical pump circuit independent of engine operation.

Efficient operation of a powertrain system depends on various factors, including operating conditions and load demands. Heating and/or cooling engine oil and/or transmission oil via heat exchangers and heat sinks provides some measure of temperature control. However, many systems include multiple pathways and components that increase system complexity and introduce packaging constraints.

### SUMMARY

Embodiments according to the present disclosure provide a number of advantages. For example, embodiments according to the present disclosure use a single rotary valve integrated into a legacy thermal system to allow for active warm-up control of transmission and engine oil.

In one aspect of the present disclosure, a system for controlling fluid temperature in a thermal system includes a heat source, a single heat sink coupled to the heat source such that a flow of coolant passes between the heat source and the heat sink, a first heat exchanger coupled to the heat source, a second heat exchanger coupled to the heat source, a valve coupled to the heat source, the first heat exchanger, the second heat exchanger, and the heat sink, the valve configured to regulate the flow of coolant between the heat source, the first heat exchanger, the second heat exchanger, and the heat sink, and a controller in electronic communication with the heat source and the valve. The controller is configured to determine an operating condition of the thermal system and generate a control signal to control the valve to direct the flow of coolant to one or more of the first and second heat exchangers and the heat source.

In some aspects, the heat source is an engine.

In some aspects, the heat sink is a radiator.

In some aspects, the first heat exchanger is an engine oil heat exchanger.

In some aspects, the second heat exchanger is a transmission oil heat exchanger.

In some aspects, the valve is a multi-position rotary valve.

In some aspects, the operating condition includes a first operating condition and a second operating condition, the first operating condition including operation of the heat source in a hot environment and the second operating condition including operation of the heat source in a cold environment.

In some aspects, in response to a determination by the controller of operation under the first operating condition, the controller generates a first control signal to control the valve to direct a flow of cooled coolant received from the heat sink to one or both of the first and second heat exchangers to lower a temperature of a fluid returned to the heat source.

In some aspects, in response to a determination by the controller of operation under the second operating condition, the controller generates a second control signal to control the valve to direct a flow of warm coolant received from the heat source to one or both of the first and second heat exchangers to increase the temperature of the fluid returned to the heat source.

In another aspect of the present disclosure, a method for temperature control of a thermal system includes providing a system for controlling fluid temperature. The system includes a heat source, a heat sink fluidically coupled to the heat source, a first heat exchanger coupled to the heat source, a second heat exchanger coupled to the heat source, a valve coupled to the heat source, the first heat exchanger, the second heat exchanger, and the heat sink, the valve configured to regulate a flow of coolant between the heat source, the first heat exchanger, the second heat exchanger, and the heat sink, and a controller in electronic communication with the heat source and the valve. The method further includes determining, by the controller, an operating condition of the thermal system, wherein the operating condition includes a first operating condition and a second operating condition, and, in response to determining operation of the thermal system in the first operating condition, generating, by the controller, a first control signal to control the valve to direct a flow of cool coolant to one or both of the first and second heat exchangers to lower a temperature of a fluid returned to the heat source. The method also includes, in response to determining operation of the thermal system in the second operating condition, generating, by the controller, a second control signal to control the valve to direct a flow of warm coolant received from the heat source to one or both of the first and second heat exchangers to increase the temperature of the fluid returned to the heat source.

In some aspects, the heat source is an engine and the heat sink is a radiator.

In some aspects, the first heat exchanger is an engine oil heat exchanger.

In some aspects, the second heat exchanger is a transmission oil heat exchanger.

In some aspects, the valve is a multi-position rotary valve.

In some aspects, the operating condition includes a first operating condition and a second operating condition, the first operating condition including operation of the heat source in a hot environment and the second operating condition including operation of the heat source in a cold environment.

In another aspect of the present disclosure, an automotive vehicle includes an engine, a radiator fluidically coupled to the engine, an engine oil heat exchanger fluidically coupled to the engine, a transmission oil heat exchanger coupled to the engine, a multi-position valve coupled to the engine, the engine oil heat exchanger, the transmission oil heat exchanger, and the radiator, the multi-position valve configured to regulate a flow of coolant between the engine, the engine oil heat exchanger, the transmission oil heat exchanger, and the radiator, and a controller in electronic communication with the engine and the multi-position valve. The controller is configured to determine an operating condition of the engine and generate a control signal to control the multi-position valve to direct the flow of coolant to one or more of the engine oil and the transmission oil heat exchangers to thermally regulate a temperature of a fluid returned to the engine.

In some aspects, the multi-position valve is a single rotary valve.

In some aspects, the operating condition includes a first operating condition and a second operating condition, the first operating condition including operation of the engine in a hot environment and the second operating condition including operation of the engine in a cold environment.

In some aspects, in response to a determination by the controller of operation under the first operating condition, the controller generates a first control signal to control the multi-position valve to direct a flow of cooled coolant received from the radiator to one or both of the first and second heat exchangers to lower a temperature of a fluid returned to the engine.

In some aspects, in response to a determination by the controller of operation under the second operating condition, the controller generates a second control signal to control the multi-position valve to direct a flow of warm coolant received from the engine to one or both of the first and second heat exchangers to increase the temperature of the fluid returned to the engine.

### BRIEF DESCRIPTION OF THE DRAWINGS

The present disclosure will be described in conjunction with the following figures, wherein like numerals denote like elements.

FIG. 1 is a schematic diagram of a thermal system including a valve configured to direct fluid to an engine and/or a transmission, according to an embodiment of the disclosure.

FIG. 2 is a flowchart of a method for control of a thermal system including a heat source, such as an engine, according to an embodiment of the disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “Left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

A combination of rotary valve technology into a legacy thermal system allows for active warm-up control of transmission and engine oil. The embodiment discussed herein utilizes a single rotary valve to direct warm coolant from an engine to a transmission or heat exchanger to increase the rate of warm-up of these components in cold operating conditions. Additionally, in warm operating conditions having additional cooling demands, a secondary path from the single rotary valve provides cooling flow to the transmission and/or engine oil. The integrated valve is continuously exposed to flow based on engine speed via a mechanical pump and operates as a temperature control for the transmission and engine oil.

In various embodiments, the integrated valve allows for operation of thermal control above coolant feed temperatures, increasing vehicle efficiency. Additionally, the valve allows for the combination of a single heat sink source (such as, for example, a radiator) to provide cooling for both the engine oil and the transmission oil.

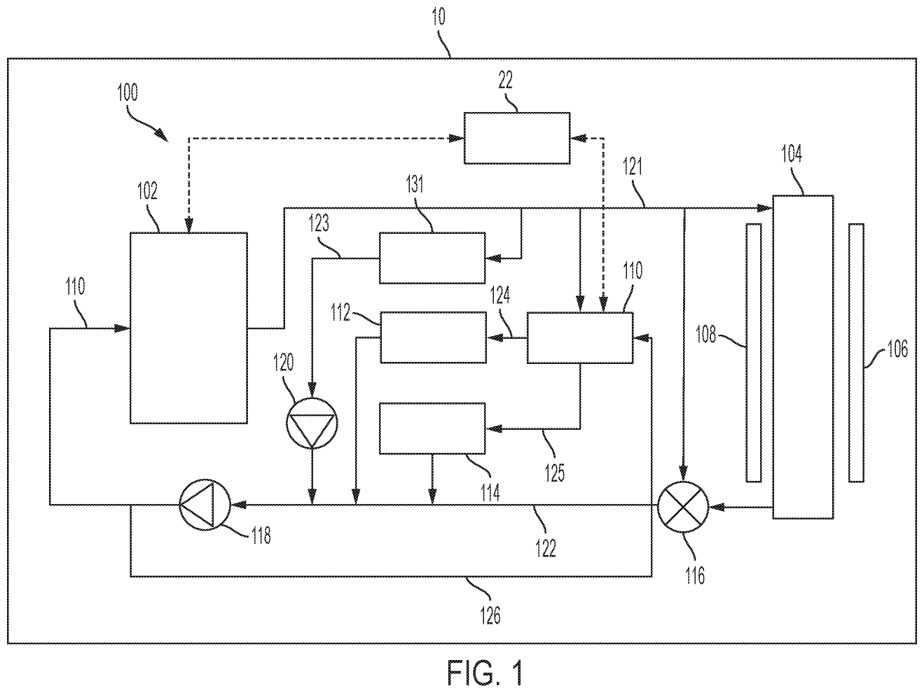

FIG. 1 is a schematic illustration of a thermal system 100 with independent heating and cooling operation, according to an embodiment. The thermal system 100 includes, in some embodiments, a heat source 102 and a heat sink 104. In various embodiments, the heat source 102 is an engine 102 and the heat sink 104 is a radiator 104. When the heat source 102 is an engine, the engine can be any type or configuration of an internal combustion engine. In various embodiments, the thermal system 100 also includes a condenser 106, a fan 108, and a valve 110. In various embodiments, the valve 110 is a single multi-position rotary valve configured to receive both heated and cooled fluid and direct the fluid to one or more components, as discussed herein. In some embodiments, the thermal system 100 is a system of a vehicle 10.

In various embodiments, the thermal system 100 includes at least one controller 22. The heat source 102 and the valve 110 are in electronic communication with the at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the connected components.

The thermal system 100 further includes, for example and without limitation, an engine oil heat exchanger 112 and a transmission oil heat exchanger 114, one or more thermostats, such as a thermostat 116, a pump 118, a pump 120, and a heater core 121. Each of the pumps 118, 120 is, in some embodiments, a mechanical pump. In various embodiments, the thermostat 116, the heat exchangers 112, 114, the pumps 118, 120, and the heater core 121 are in electronic communication with the controller 22. In various embodiments, the controller 22 receives data from the thermostat 116 regarding the temperature of coolant fluid and, based on one or more factors, including the temperature data, operating conditions of the heat source 102, a demanded heating or cooling level, etc., generates one or more control signals to control the flow of coolant via the valve 110.

The valve 110 facilitates active heating and/or cooling of a fluid, such as engine or transmission oil, as shown in FIG. 1 by the flow paths discussed herein. Heated fluid from the heat source 102 (such as engine oil) flows along a first flow path 121 toward the heat sink 104, the condenser 106, and the fan 108. The hot fluid is cooled and returns to the heat source 102 via a second flow path 122 that includes the thermostat 116 configured to monitor the temperature of the fluid returning to the heat source 102. In various embodiments, the pump 118 assists the flow of cooled fluid toward the heat source 102.

Some of the fluid from the heat source 102 is diverted to the heater core 121. The heater core 121 heats the fluid and return it to the heat source 102 via a third flow path 123. In various embodiments, the third flow path 123 includes an auxiliary pump 120 to assist the flow of fluid back to the heat source 102. In various embodiments, configuring the path of coolant from the heat source 102 to the heater core 121 and providing the heated coolant to the valve 110 enables the valve 110 to direct heated coolant to either or both of the engine oil heat exchanger 112 and the transmission oil heat exchanger 114, enabling a faster warm-up and friction reduction of the heat source 102.

Additionally, some of the fluid from the heat source 102 is diverted to the thermostat 116 and is then routed back to the heat source 102 via the second flow path 122.

Fluid from the heat source 102 is also routed to the valve 110. The valve 110 receives the fluid from the heat source 102 and routes the fluid as needed to provide thermal control for the heat source via components such as the engine oil heat exchanger 112 and the transmission oil heat exchanger 114. In various aspects, a demanded heating condition is determined by the controller 22 in electronic communication with one or more components of the system 100, including the valve 110. The valve 110 directs fluid received via the first flow path 121 from the heat source 102 to one or both of the engine oil heat exchanger 112 (via a fourth flow path 124) and the transmission oil heat exchanger 114 (via a fifth flow path 125) based on the demanded condition. The heated fluid from the heat source 102 is used for active warm-up control of the transmission and engine oil via the heat exchangers 112, 114. The heated engine oil from the engine oil heat exchanger 112 returns to the heat source 102 via the second flow path 122. Similarly, the heated transmission oil from the transmission oil heat exchanger 114 returns to the heat source 102 via the second flow path 122.

The valve 110 also receives cooled fluid from the heat sink 104 via a sixth flow path 126. The cooled fluid from the heat sink 104 is also directed to one or both of the engine oil heat exchanger 112 (via the fourth flow path 124) and the transmission oil heat exchanger 114 (via the fifth flow path 125), based on a demanded cooling condition, which is also determined by the controller 22 in electronic communication with one or more components of the system 100, including the valve 110. As discussed above, the cooled fluid is returned to the heat source 102 from one or both of the heat exchangers 112, 114 via the second flow path 122. The valve 110 allows for operation of thermal control above coolant feed temperatures, increasing efficiency of the heat source 102, or, in some embodiments, when the heat source 102 is an engine, increasing vehicle efficiency. As shown in FIG. 1, the valve 110 allows a single heat sink, such as the heat sink 104, to provide cooling for the engine oil and transmission oil.

Using the multi-position rotary valve 110 enables a constant, high flow rate of coolant fluid to connected components, such as the heat exchangers 112, 114. This constant, high flow rate of coolant enables transmission and/or engine oil warm up targeting set points above engine coolant temperatures that is accomplished by applying warm coolant, cold coolant, or no coolant flow to the engine oil heat exchanger 112 and/or the transmission oil heat exchanger 114. Additionally, under heavy operating conditions, such as a maximum towing operation, the valve 110 enables a flow of coolant to deliver transmission and/or engine oil cooling to or below target engine coolant levels. In extreme cold operating conditions, the valve 110 is configured to reduce or stop the flow of coolant based on demands by the heater core 118. Furthermore, the valve 110 provides pressure relief for the system 100 by forcing fluid flow through the heat exchangers 112, 114 from the cooling or warming sources (that is, the heat sink 104 and the heat source 102), avoiding additional bypass circuits that increase the mechanical and packaging complexities of the system 100.

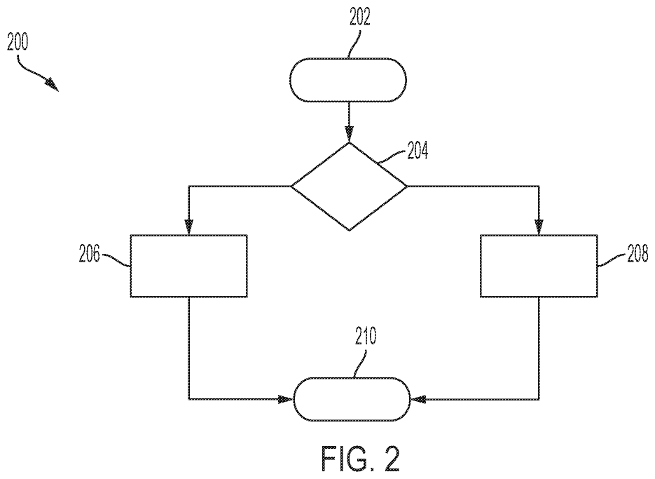

FIG. 2 illustrates a method 200 for temperature control of a thermal system, according to an embodiment. The method 200 can be utilized in connection with the system 100 discussed herein. The method 200 can be utilized in connection with the controller 22 as discussed herein, or by other systems associated with or separate from the thermal system, in accordance with exemplary embodiments. The order of operation of the method 200 is not limited to the sequential execution as illustrated in FIG. 2, but may be performed in one or more varying orders, or steps may be performed simultaneously, as applicable in accordance with the present disclosure.

The method 200 begins at 202 and proceeds to 204. At 204, the controller 22 determines an operating condition of the heat source 102. In various embodiments, the operating condition is one of a first operating condition and a second operating condition. In various embodiments, the first operating condition includes operation in a hot environment in which the ambient air temperature is greater than approximately eighty (80) degrees Fahrenheit and/or operation in a heavy load condition, such as a towing operation. In various embodiments, the second operating condition includes operation in a cold environment in which the ambient air temperature is less than approximately fifteen (15) degrees Fahrenheit. The higher temperature differential between the coolant and the outside air makes heat transfer more efficient, leading to more efficient operation of the heat source 102.

If the determination at 204 is that the heat source 102 is operating in the first operating condition, the method 200 proceeds to 206. At 206, the controller 22 controls the valve 110 to direct a flow of cooled coolant received from the heat sink 104 to one or both of the engine oil heat exchanger 112 and the transmission oil heat exchanger 114. The flow of cooled coolant to the heat exchangers 112, 114 controls the temperature of the different oil sumps based on the first operating condition to provide improved fuel economy and friction reduction.

If the determination at 204 is that the heat source 102 is operating in the second operating condition, the method 200 proceeds to 208. At 208, the controller 22 controls the valve 110 to direct a flow of warm coolant received from the heat source 102 to one or both of the engine oil heat exchanger 112 and the transmission oil heat exchanger 114. The flow of heated coolant to the heat exchangers 112, 114 provides a faster warm-up and reduces operation friction.

From both 206 and 208, the method 200 proceeds to 210 and ends. In various embodiments, the method 200 repeats as the controller 22 receives data from sensors or other devices associated with the heat source 102 to determine current operating conditions.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system for controlling fluid temperature in a thermal system, comprising:
a heat source;
a heat sink coupled to the heat source such that a flow of coolant passes between the heat source and the heat sink;
a first heat exchanger coupled to the heat source;
a second heat exchanger coupled to the heat source;
a valve coupled to the heat source, the first heat exchanger, the second heat exchanger, and the heat sink, the valve configured to regulate the flow of coolant between the heat source, the first heat exchanger, the second heat exchanger, and the heat sink; and
a controller in electronic communication with the heat source and the valve, the controller configured to determine an operating condition of the thermal system and generate a control signal to control the valve to direct the flow of coolant to one or more of the first and second heat exchangers and the heat source.

2. The system of claim 1, wherein the heat source is an engine.

3. The system of claim 1, wherein the heat sink is a radiator.

4. The system of claim 1, wherein the first heat exchanger is an engine oil heat exchanger.

5. The system of claim 1, wherein the second heat exchanger is a transmission oil heat exchanger.

6. The system of claim 1, wherein the valve is a single multi-position rotary valve, the first heat exchanger is an engine oil heat exchanger, the second heat exchanger is a transmission oil heat exchanger, and the heat sink is a single radiator.

7. The system of claim 1, wherein the operating condition includes a first operating condition and a second operating condition, the first operating condition including operation of the heat source in a hot environment and the second operating condition including operation of the heat source in a cold environment.

8. The system of claim 7, wherein, in response to a determination, by the controller, that the thermal system is operating in the first operating condition, the controller generates a first control signal to control the valve to direct a flow of cooled coolant received from the heat sink to one or both of the first and second heat exchangers to lower a temperature of a fluid returned to the heat source.

9. The system of claim 8, wherein, in response to a determination, by the controller, that the thermal system is operating in the second operating condition, the controller generates a second control signal to control the valve to direct a flow of warm coolant received from the heat source to one or both of the first and second heat exchangers to increase the temperature of the fluid returned to the heat source.

10. A method for temperature control of a thermal system, the method comprising:
providing a system for controlling fluid temperature, the system including
a heat source;
a heat sink fluidicly coupled to the heat source;
a first heat exchanger coupled to the heat source;
a second heat exchanger coupled to the heat source;
a valve coupled to the heat source, the first heat exchanger, the second heat exchanger, and the heat sink, the valve configured to regulate a flow of coolant between the heat source, the first heat exchanger, the second heat exchanger, and the heat sink; and
a controller in electronic communication with the heat source and the valve;
determining, by the controller, an operating condition of the thermal system, wherein the operating condition includes a first operating condition and a second operating condition;
in response to determining that the thermal system is operating in the first operating condition, generating, by the controller, a first control signal to control the valve to direct a flow of cool coolant to one or both of the first and second heat exchangers to lower a temperature of a fluid returned to the heat source; and
in response to determining operation of the thermal system in the second operating condition, generating, by the controller, a second control signal to control the valve to direct a flow of warm coolant received from the heat source to one or both of the first and second heat exchangers to increase the temperature of the fluid returned to the heat source.

11. The method of claim 10, wherein the heat source is an engine and the heat sink is a radiator.

12. The method of claim 10, wherein the first heat exchanger is an engine oil heat exchanger.

13. The method of claim 10, wherein the second heat exchanger is a transmission oil heat exchanger.

14. The method of claim 10, wherein the valve is a single multi-position rotary valve.

15. The method of claim 10, wherein the operating condition includes a first operating condition and a second operating condition, the first operating condition including operation of the heat source in a hot environment and the second operating condition including operation of the heat source in a cold environment.

16. An automotive vehicle, comprising:
an engine;
a radiator fluidicly coupled to the engine;
an engine oil heat exchanger fluidicly coupled to the engine;
a transmission oil heat exchanger coupled to the engine;
a multi-position valve coupled to the engine, the engine oil heat exchanger, the transmission oil heat exchanger, and the radiator, the multi-position valve configured to regulate a flow of coolant between the engine, the engine oil heat exchanger, the transmission oil heat exchanger, and the radiator; and
a controller in electronic communication with the engine and the multi-position valve, the controller configured to determine an operating condition of the engine and generate a control signal to control the multi-position valve to direct the flow of coolant to one or more of the engine oil and the transmission oil heat exchangers to thermally regulate a temperature of a fluid returned to the engine.

17. The automotive vehicle of claim 16, wherein the multi-position valve is a single rotary valve.

18. The automotive vehicle of claim 16, wherein the operating condition includes a first operating condition and a second operating condition, the first operating condition including operation of the engine in a hot environment and the second operating condition including operation of the engine in a cold environment.

19. The automotive vehicle of claim 18, wherein, in response to a determination, by the controller, that the thermal system is operating in the first operating condition, the controller generates a first control signal to control the multi-position valve to direct a flow of cooled coolant received from the radiator to one or both of the engine oil and transmission oil heat exchangers to lower a temperature of a fluid returned to the engine.

20. The automotive vehicle of claim 19, wherein, in response to a determination by the controller of operation under the second operating condition, the controller generates a second control signal to control the multi-position valve to direct a flow of warm coolant received from the engine to one or both of the engine oil and transmission oil heat exchangers to increase the temperature of the fluid returned to the engine.
